(19) United States
(12) Patent Application Publication
(10) Pub. No.: US 2013/0009344 A1
(43) Pub. Date: Jan. 10, 2013

(54) METHOD FOR PRODUCING PNEUMATIC TIRE

(75) Inventors: Takuzo Sano, Kanagawa (JP); Noboru Takada, Kanagawa (JP)

(73) Assignee: THE YOKOHAMA RUBBER CO., LTD., MINATO-KU, TOKYO (JP)

(21) Appl. No.: 13/634,646

(22) PCT Filed: Mar. 2, 2011
(86) PCT No.: PCT/JP2011/054803

§ 371 Date: Sep. 13, 2012

(30) Foreign Application Priority Data
Mar. 30, 2010 (JP) 2010-077891

(51) Int. Cl. B29D 30/08

(52) U.S. Cl. 264/326

(57) ABSTRACT

A primary formed body is formed by fitting bead rings to outside end portions of a cylindrical body having a film and a carcass material disposed on an outer peripheral side of the film. A green tire is formed on a rigid inner mold by causing a center portion of the primary formed body to bulge toward an outer peripheral side, and holding the center portion by suction on the inner peripheral surface of the transferring/holding mold having a similar shape to the outer peripheral surface of the rigid inner mold, and suspending the suction with the transferring/holding mold, and transferring the primary formed body to an outer peripheral surface of a bladder. The bladder has a uniform thickness and an outer peripheral surface in a neutral state similar to a profile of an inner peripheral surface of a tire to be produced. The green tire is vulcanized.

### TECHNICAL FIELD

The present invention relates to a method for producing a pneumatic tire, and more specifically to a method for producing a pneumatic tire, the method being capable of producing a light-weight pneumatic tire excellent in air-permeation prevention performance and uniformity.

### BACKGROUND ART

Various methods for producing a pneumatic tire have been proposed in which a green tire is formed on an outer peripheral surface of a rigid inner mold made of a metal, and the formed green tire is vulcanized, while being disposed inside a vulcanizing mold together with the rigid inner mold (for example, see Patent Document 1). Such a production method using a rigid inner mold enables the formation of a green tire having a similar shape to that of a tire to be produced, and hence makes it possible to reduce the load acting on the green tire during the vulcanization.

However, it is difficult to form a green tire by stably layering tire-constituting members such as an inner liner while fitting these tire-constituting members to an outer peripheral surface of the rigid inner mold. This difficulty is a factor of hindering the improvement in uniformity of a tire.

In addition, butyl rubber has mainly been used for an inner liner (an innermost peripheral layer) of a green tire. To facilitate the peeling of the inner liner from the outer peripheral surface of the rigid inner mold, additional operations such as application of a release agent are necessary. In addition, to secure a sufficient air-permeation prevention performance, an inner liner made of butyl rubber alone has to have a certain thickness. Hence, the inner liner is disadvantageous for the weight reduction of a tire. For this reason, pneumatic tires have been desired to meet specifications with excellent air-permeation prevention performance and a light weight.

### Prior Art Document

### Patent Document

Patent Document 1: Japanese patent application Kokai publication No. 2010-30242

### SUMMARY OF THE INVENTION

### Problem to be Solved by the Invention

An object of the present invention is to provide a method for producing a pneumatic tire, the method being capable of producing a light-weight pneumatic tire excellent in air-permeation prevention performance and uniformity.

### Means for Solving the Problem

To achieve the above object, a method for producing a pneumatic tire of the present invention is a method in which a green tire is formed on an outer periphery of a cylindrical rigid inner mold including a plurality of divided bodies and having an outer peripheral surface with a similar shape to a profile of an inner peripheral surface of a tire to be produced, and then the green tire is vulcanized, the method characterized by comprising:

forming a primary formed body in such a manner that
bead rings are fitted to the outside of both end portions in a widthwise direction of a cylindrical body having at least a film made of a thermoplastic resin or a thermoplastic elastomer composition obtained by blending an elastomer with a thermoplastic resin, and a carcass material disposed on an outer peripheral side of the film;

forming a green tire in such a manner that
a center portion in the widthwise direction of the primary formed body is caused to bulge toward an outer peripheral side, and is held by suction on an inner peripheral surface of a transferring/holding mold having a similar shape to the outer peripheral surface of the rigid inner mold,
in a state where the rigid inner mold to the outside of which a bladder is fitted is disposed inside the primary formed body held by suction, the suction with the transferring/holding mold is suspended and the primary formed body is transferred to an outer peripheral surface of the bladder, the bladder having a uniform thickness and having the outer peripheral surface that is nearly the same in a neutral state as the profile of the inner peripheral surface of the tire to be produced, and
subsequently both end portions in the widthwise direction of the carcass material are turned up on the outer periphery of the rigid inner mold, and another tire-constituting member is layered on an outer peripheral surface of the primary formed body; and

vulcanizing the green tire in such a manner that
the green tire is disposed inside a vulcanizing mold placed in a vulcanizing apparatus, together with the rigid inner mold to the outside of which the bladder is fitted, and the vulcanizing mold is clamped, and
the vulcanizing mold is heated to a predetermined temperature, and the bladder is inflated from an inner peripheral side thereof with a heating fluid.

Another method for producing a pneumatic tire of the present invention is a method in which a green tire is formed on an outer periphery of a cylindrical rigid inner mold including a plurality of divided bodies and having an outer peripheral surface with a similar shape to a profile of an inner peripheral surface of a tire to be produced, and then the green tire is vulcanized, the method characterized by comprising:

forming a primary formed body in such a manner that
bead rings are fitted to the outside of both end portions in a widthwise direction of a cylindrical body having at least a film made of a thermoplastic resin or a thermoplastic elastomer composition obtained by blending an elastomer with a thermoplastic resin, and a carcass material disposed on an outer peripheral side of the film;

forming a green tire in such a manner that
a center portion in the widthwise direction of the primary formed body is caused to bulge toward an outer peripheral side, and is held by suction on an inner peripheral surface of a transferring/holding mold having a similar shape to the outer peripheral surface of the rigid inner mold,
in a state where the rigid inner mold to the outside of which a bladder is fitted is disposed inside the primary formed body held by suction, the suction with the transferring/holding mold is suspended and the primary formed body is transferred to an outer peripheral surface of the bladder, the bladder having a uniform thickness and having the outer peripheral surface that is nearly the same in a neutral state as the profile of the inner peripheral surface of the tire to be produced, and
subsequently both end portions in the widthwise direction of the carcass material are turned up on the outer periphery of the rigid inner mold, and another tire-constituting member is layered on an outer peripheral surface of the primary formed body; and

vulcanizing the green tire in such a manner that
after the rigid inner mold is detached from the green tire, the green tire to the inside of which the bladder is fitted is disposed inside a vulcanizing mold placed in an vulcanizing apparatus, and the vulcanizing mold is clamped, and
the vulcanizing mold is heated to a predetermined temperature, and the bladder is inflated from an inner peripheral side thereof with a heating fluid.

### Effects of the Invention

According to the method for producing a pneumatic tire of the present invention, the film made of the thermoplastic resin or the thermoplastic elastomer composition is layered in the primary formed body. Hence, the primary formed body can be stably held by suction, while being precisely fitted to the inner peripheral surface of the transferring/holding mold, in a case where the center portion in the widthwise direction of the primary formed body is caused to bulge toward the outer peripheral side, and the primary formed body is held by suction on the inner peripheral surface of the transferring/holding mold having a similar shape to the outer peripheral surface of the rigid inner mold. In addition, in a state where the rigid inner mold to the outside of which the bladder is fitted is disposed inside the primary formed body, the suction with the transferring/holding mold is suspended, and the primary formed body is transferred to the outer peripheral surface of the bladder, the bladder having a uniform thickness and having the outer peripheral surface that is nearly the same in a neutral state as the profile of the inner peripheral surface of the tire to be produced. Hence, the primary formed body can be layered on the outer peripheral surface of the bladder, while being precisely fitted thereto.

The bladder is fixed to the rigid inner mold by being fitted to the outside thereof. Hence, decentering and the like of a green tire formed on the outer peripheral surface are prevented, and a green tire precisely fitted to the outer peripheral surface of the bladder can be formed stably. This is advantageous for improving the uniformity of the tire to be produced.

The green tire disposed inside the vulcanizing mold is vulcanized in such a manner that the vulcanizing mold is heated to a predetermined temperature, and the bladder fitted to the inside of the green tire is inflated from the inner peripheral side with the heating fluid. Hence, the unvulcanized rubber of the tire-constituting members is pressed toward the inner peripheral surface of the vulcanizing mold, and flows in the circumferential direction. As a result, even when the volumes of the tire-constituting members are unevenly distributed, the unevenness is corrected. This makes it possible to further improve the uniformity of the tire to be produced. Since the bladder is used, steam can be used as a heating fluid for the vulcanization of the green tire.

The film made of the thermoplastic resin or the thermoplastic elastomer composition is layered on the inner peripheral side of the tire produced in this manner. Hence, it is possible to obtain a lighter weight and a better air-permeation prevention performance than those of conventional inner liners made of butyl rubber alone.

The formed green tire is supported by the rigid inner mold, until vulcanized, in a case where the green tire is vulcanized, while being disposed inside the vulcanizing mold placed in the vulcanizing apparatus, together with the rigid inner mold to the outside of which the bladder is fitted. Hence, it is possible to reduce the occurrence of unnecessary deformation.

The rigid inner mold can be used freely during the vulcanization in a case where the rigid inner mold is detached from the green tire, and then the green tire to the inside of which the bladder is fitted is vulcanized, while being disposed inside the vulcanizing mold placed in the vulcanizing apparatus. For this reason, the number of green tires which can be formed with one rigid inner mold in a certain period is increased, so that the productivity can be improved by effectively utilizing the rigid inner mold.

Here, it is also possible to dispose the transferring/holding mold on the outer peripheral side of the primary formed body, and apply a pressure to the primary formed body from the inner peripheral side thereof, in the course of holding the primary formed body by suction on the inner peripheral surface of the transferring/holding mold. In this case, it is easier to fit the primary formed body precisely to the inner peripheral surface of the transferring/holding mold.

In the vulcanization of the green tire, for example, the bladder is inflated at a pressure of 0.01 MPa to 3.0 MPa from the inner peripheral side. This pressure enables a favorable vulcanization without any excessive load on the green tire.

It is also possible to vulcanize the green tire disposed inside the vulcanizing mold, while air is being sucked from the inside to the outside of the vulcanizing mold. In this case, air between the layered tire-constituting members and air in the tire-constituting members (rubber members) can be removed. Hence, problems due to air inclusion in the produced tire can be prevented, and the quality thereof can be improved.

It is also possible to locate the film at the innermost periphery of the primary formed body. In the case of this specification, the tire to be produced can be further reduced in weight.

### BRIEF DESCRIPTION OF THE DRAWINGS

FIG. 1 is a vertical cross-sectional view illustrating a step of forming a primary formed body.

FIG. 2 is a cross-sectional view taken along A-A of FIG. 1.

FIG. 3 is a vertical cross-sectional view illustrating a state where a space-adjusting plate is connected to carcass-fixing rings of FIG. 1.

FIG. 4 is an upper-half vertical cross-sectional view illustrating a state where an inflation mold is being placed inside the primary formed body.

FIG. 5 is an upper-half vertical cross-sectional view illustrating a state where the primary formed body is caused to bulge toward an outer peripheral side.

FIG. 6 is a vertical cross-sectional view illustrating an internal structure of the inflation mold of FIG. 4.

FIG. 7 is an upper-half vertical cross-sectional view illustrating a step of holding the primary formed body by suction with a transferring/holding mold.

FIG. 8 is an upper-half vertical cross-sectional view illustrating a step of placing a bladder inside the primary formed body.

FIG. 9 is an upper-half vertical cross-sectional view illustrating a step of placing a rigid inner mold inside the bladder.

FIG. 10 is a front view of the rigid inner mold.

FIG. 11 is a cross-sectional view taken along B-B of FIG. 10.

FIG. 12 is an upper-half vertical cross-sectional view illustrating a state where a green tire is formed on an outer peripheral surface of the rigid inner mold.

FIG. 13 is an upper-half vertical cross-sectional view illustrating a step of detaching the rigid inner mold from the green tire to the inside of which the bladder is fitted.

FIG. 14 is a vertical cross-sectional view illustrating a state where the green tire from which the rigid inner mold is detached is being vulcanized.

FIG. 15 is a partially enlarged view of FIG. 14.

FIG. 16 is a cross-sectional view taken along C-C of FIG. 14.

FIG. 17 is a vertical cross-sectional view illustrating a state where the green tire on which the rigid inner mold is mounted is being vulcanized.

FIG. 18 is a partially enlarged view of FIG. 17.

FIG. 19 is a cross-sectional view taken along D-D of FIG. 17.

FIG. 20 is a half meridian cross-sectional view illustrating a pneumatic tire produced by the present invention.

### MODES FOR CARRYING OUT THE INVENTION

Hereinafter, methods for producing a pneumatic tire of the present invention are described based on embodiments shown in the drawings. Note that the same members are denoted by the same reference signs before and after vulcanization.

FIG. 20 illustrates a pneumatic tire 21 produced by the present invention. In the pneumatic tire 21, a carcass material 24 is laid between a pair of bead rings 25, and is folded back around bead cores 25a from the inside to the outside, with bead fillers 25b sandwiched therebetween. A tie rubber 23 and a film 22 are layered in this order on an inner peripheral side of the carcass material 24. The film 23 at the innermost periphery prevents air permeation. The thickness of the film 22 is, for example, 0.005 mm to 0.2 mm.

The film 22 and the carcass material 24 are joined to each other in a favorable manner, with the tie rubber 23 interposed therebetween. Rubber members constituting sidewall portions 26 and a rubber member constituting a tread portion 28 are provided on an outer peripheral side of the carcass material 24. Note that it is also possible to employ such a specification that an inner liner made of butyl rubber is layered on an inner peripheral side of the film 22.

Belt layers 27 are provided on the outer peripheral side of the carcass material 24 in the tread portion 28 over the entire periphery of the tire in a tire circumferential direction. Reinforcing cords constituting the belt layers 27 are disposed, while inclined from the tire circumferential direction. In addition, in the layered belt layers 27, the reinforcing cords are disposed such that the reinforcing cords of an upper belt layer and the reinforcing cords of a lower belt layer cross each other. The structure of the pneumatic tire 1 produced by the present invention is not limited to that of FIG. 20. The present invention can be applied to the production of pneumatic tires of other structures.

The film 22 used in the present invention includes a thermoplastic resin or a thermoplastic elastomer composition obtained by blending an elastomer with a thermoplastic resin.

Examples of the thermoplastic resin include polyamide-based resins [for example, nylon 6 (N6), nylon 66 (N66), nylon 46 (N46), nylon 11 (N11), nylon 12 (N12), nylon 610 (N610), nylon 612 (N612), nylon 6/66 copolymers (N6/66), nylon 6/66/610 copolymers (N6/66/610), nylon MXD6, nylon 6T, nylon 6/6T copolymers, nylon 66/PP copolymers, and nylon 66/PPS copolymers], polyester-based resins [for example, aromatic polyesters such as polybutylene terephthalate (PBT), polyethylene terephthalate (PET), polyethylene isophthalate (PEI), polybutylene terephthalate/tetramethylene glycol copolymers, PET/PEI copolymers, polyarylates (PAR), polybutylene naphthalate (PBN), liquid crystal polyesters, and polyoxyalkylene diimide diacid/polybutylene terephthalate copolymers], polynitrile-based resins [for example, polyacrylonitrile (PAN), polymethacrylonitrile, acrylonitrile/styrene copolymers (AS), methacrylonitrile/styrene copolymers, and methacrylonitrile/styrene/butadiene copolymers], poly(meth)acrylate-based resins [for example, polymethyl methacrylate (PMMA), polyethyl methacrylate, ethylene-ethyl acrylate copolymers (EEA), ethylene-acrylic acid copolymers (EAA), and ethylene-methyl acrylate resins (EMA)], polyvinyl-based resins [for example, vinyl acetate (EVA), polyvinyl alcohol (PVA), vinyl alcohol/ethylene copolymers (EVOH), polyvinylidene chloride (PVDC), polyvinyl chloride (PVC), vinyl chloride/vinylidene chloride copolymers, and vinylidene chloride/methyl acrylate copolymers], cellulose-based resins [for example, cellulose acetate and cellulose acetate butyrate], fluororesins [for example, polyvinylidene fluoride (PVDF), polyvinyl fluoride (PVF), polychlorofluoroethylene (PCTFE), and tetrafluoroethylene/ethylene copolymers (ETFE)], imide-based resins [for example, aromatic polyimides (PI)], and the like.

Examples of the elastomer include diene-based rubbers and hydrogenated products thereof [for example, NR, IR, epoxidized natural rubbers, SBR, BRs (high-cis BR and low-cis BR), NBR, hydrogenated NBR, and hydrogenated SBR], olefin-based rubbers [for example, ethylene propylene rubbers (EPDM and EPM) and maleic acid-modified ethylene propylene rubbers (M-EPM)], butyl rubber (IIR), copolymers of isobutylene with an aromatic vinyl or a diene-based monomer, acrylic rubber (ACM), ionomers, halogen-containing rubbers [for example, Br-IIR, Cl-IIR, brominated isobutylene-para-methylstyrene copolymers (Br-IPMS), chloroprene rubber (CR), hydrin rubber (CHC, CHR), chlorosulfonated polyethylene (CSM), chlorinated polyethylene (CM), and maleic acid-modified chlorinated polyethylene (M-CM)], silicone rubbers (for example, methyl vinyl silicone rubber, dimethyl silicone rubber, and methyl phenyl vinyl silicone rubber), sulfur-containing rubbers (for example, polysulfide rubber), fluororubbers (for example, vinylidene fluoride-based rubbers, fluorine-containing vinyl ether-based rubbers, tetrafluoroethylene-propylene-based rubbers, fluorine-containing silicon-based rubbers, and fluorine-containing phosphazene-based rubbers), thermoplastic elastomers (for example, styrene-based elastomers, olefin-based elastomers, polyester-based elastomers, urethane-based elastomers, and polyamide-based elastomer), and the like.

The weight ratio between a thermoplastic resin component

(A) and an elastomer component (B) in the thermoplastic elastomer composition used in the present invention is determined as appropriate in consideration of the balance between the thickness and flexibility of the film. For example, the weight percentage of the thermoplastic resin component (A) to the total weight of the thermoplastic resin component (A) and the elastomer component (B) is preferably 10% to 90%, and further preferably 20% to 85%.

The thermoplastic elastomer composition used in the present invention can be blended with other polymer and compounding agent such as a compatibilizer as a third component, in addition to the above-described essential components (A) and (B). The other polymer is blended for the purposes of improving the compatibility between the thermoplastic resin component and the elastomer component, improving the film formability of the material, improving the heat resistance, and reducing the costs, and for other similar purposes. Examples of a material used as the other polymer include polyethylene, polypropylene, polystyrene, ABS, SBS, polycarbonate, and the like.

The film 22 made of the thermoplastic resin or the thermoplastic elastomer composition described above is excellent in planar orientation characteristics of polymer chains, and hence has a favorable gas-barrier property. As described above, the film 22 having a better gas-barrier property than butyl rubber is employed as an inner layer in the pneumatic tire 21 produced by the present invention. Hence, the pneumatic tire 21 makes it possible to obtain a better air permeation prevention performance than those of conventional pneumatic tires which include an inner liner made of butyl rubber alone.

Moreover, the film 22 is lighter than rubber, and has a thickness of about 0.005 mm to 0.2 mm. Hence, the film 22 greatly contributes to the weight reduction of the pneumatic tire 21.

Hereinafter, a procedure for producing the pneumatic tire 21 is described.

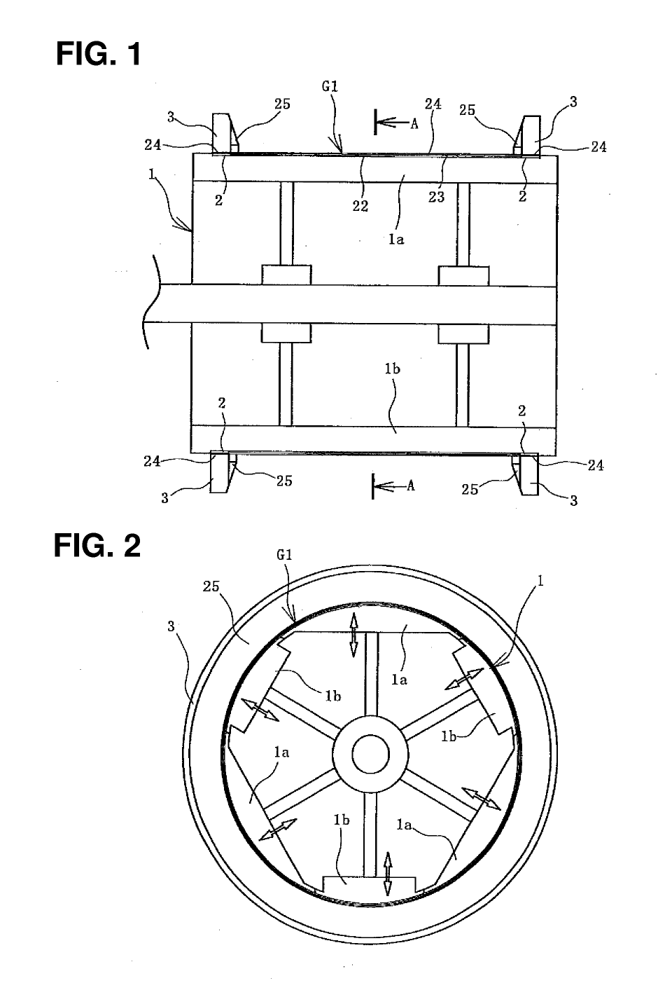

First, a primary formed body G1 is formed by using a primary making drum 1 illustrated in FIGS. 1 and 2. The primary making drum 1 includes multiple segments 1a, 1b divided in the circumferential direction. The two kinds of segments 1a, 1b are each movable in the radial direction. As a result, the primary making drum 1 forms an expandable and contractible cylindrical body.

Fixing rings 2 are fitted to the outside of both end portions in the widthwise direction of the primary making drum 1. The primary making drum 1 is made cylindrical by moving each of the segments 1a in a diameter-increasing manner. On an outer peripheral surface of the primary making drum 1 made cylindrical, the film 22, the tie rubber 23, and the carcass material 24 are disposed in a layered manner in this order to forma cylindrical body. The carcass material 24 extends further from the film 23 and the tie rubber 23 on the both sides in the widthwise direction. When such a specification that an inner liner made of butyl rubber is provided at the innermost periphery is employed, an inner liner made of unvulcanized butyl rubber, the film 22, the tie rubber 23, and the carcass material 24 are layered in this order on the outer peripheral surface of the primary making drum 1 to form a cylindrical body.

When a film 22 formed in a tubular shape in advance is used, the tubular film 22 is placed around the outside of the primary making drum 1 to make the tubular film 22 cylindrical. When a band-shaped film 22 is used, the band-shaped film 22 is wound around the outer peripheral surface of the primary making drum 1 to make the band-shaped film 22 cylindrical. In the latter case, it is also possible to form a layered body by layering in advance the band-shaped film 22 and the tie rubber 23, or the band-shaped film 22, the tie rubber 23, and the carcass material 24, and wind the layered body around the outer peripheral surface of the primary making drum 1, to make the layered body cylindrical.

Subsequently, the bead rings 25 are disposed on an outer peripheral side of both end portions in the widthwise direction of the carcass material 24, and then carcass-fixing rings 3 are disposed on an outer peripheral side of the both end portions in the widthwise direction of the carcass material 24. Thus, the both end portions in the widthwise direction of the carcass material 24 are fixed by being sandwiched between the fixing rings 2 and the carcass-fixing rings 3. Each of the bead rings 25 is fixed to the inside of the corresponding carcass-fixing ring 3. Thus, a primary formed body G1 is formed in which the bead rings 25 are fitted to the outside of the both end portions in the widthwise direction of the cylindrical body.

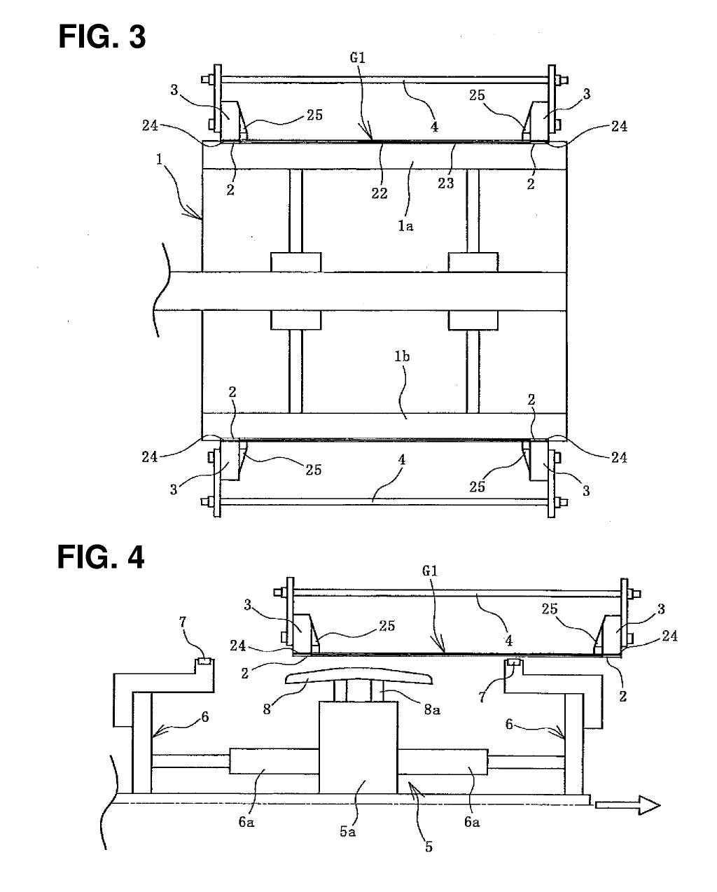

Subsequently, as illustrated in FIG. 3, the carcass-fixing rings 3 are connected to each other with a space-adjusting plate 4. The space-adjusting plate 4 is attached to the carcass-fixing rings 3 by using fixing members such as bolts.

Subsequently, the primary making drum 1 is taken out from the cylindrical primary formed body G1 by moving the segments 1a, 1b in a diameter-reducing manner. As a result, a state is achieved in which the primary formed body G1 is held by the fixing rings 2, the carcass-fixing rings 3, and the space-adjusting plate 4.

Subsequently, as illustrated in FIG. 4, a cylindrical inflation mold 5 is placed inside the primary formed body G1. As illustrated in FIGS. 4 and 6, the inflation mold 5 has disk-shaped side plates 6 on both sides in the widthwise direction of a core portion 5a, and multiple pressing plates 8 divided in the circumferential direction are provided to the core portion 5a.

Each of the side plates 6 is moved in the widthwise direction by cylinders 6a provided to the core portion 5a. In addition, expandable and contractible sealing members 7 are provided to outer peripheral portions of the side plates 6.

Each of the pressing plates 8 is configured to move in the radial direction by a cylinder 8a provided to the core portion 5a. An outer peripheral surface of the pressing plate 8 has a shape that is nearly the same as a profile of an inner peripheral surface (tread inner surface) of a tire to be produced.

After the inflation mold 5 is placed inside the primary formed body G1, the sealing members 7 are expanded, and thus peripheral portions (the fixing rings 2 and the carcass-fixing rings 3) of the bead rings 25 are firmly fixed by the side plates 6. After that, the space-adjusting plate 4 is detached from the carcass-fixing rings 3.

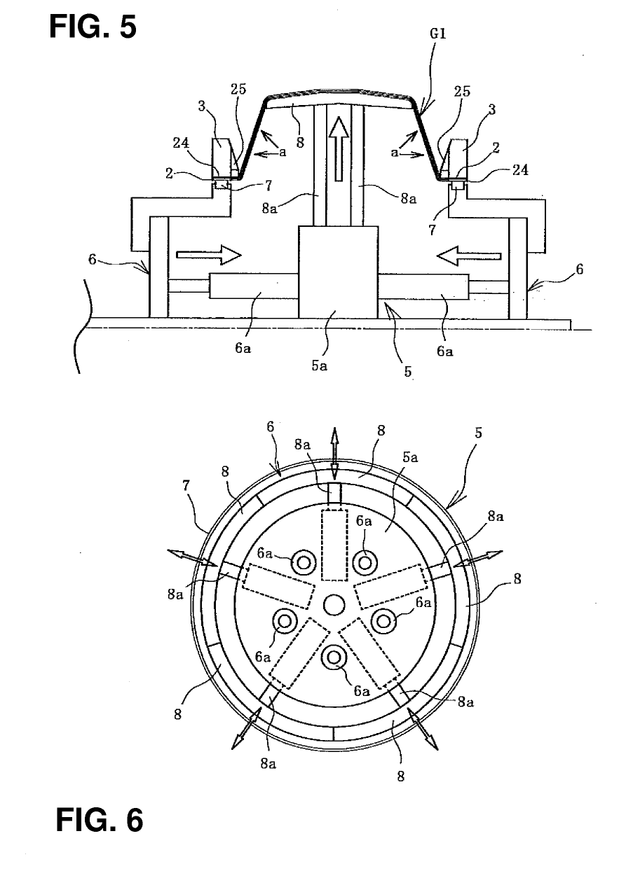

Subsequently, as illustrated in FIG. 5, each of the cylinders 6a is made free, and a rod of each of the cylinders 8a is extended. Thus, the pressing plates 8 are pressed against an inner peripheral surface of a center portion in a widthwise direction of the primary formed body G1. Simultaneously, a slight pressure is applied from the inner peripheral side by injecting air a. Thus, the primary formed body G1 is caused to bulge toward the outer peripheral side. At this time, each of the bead rings 25 (the side plates 6) moves such that the bead rings 25 approach each other.

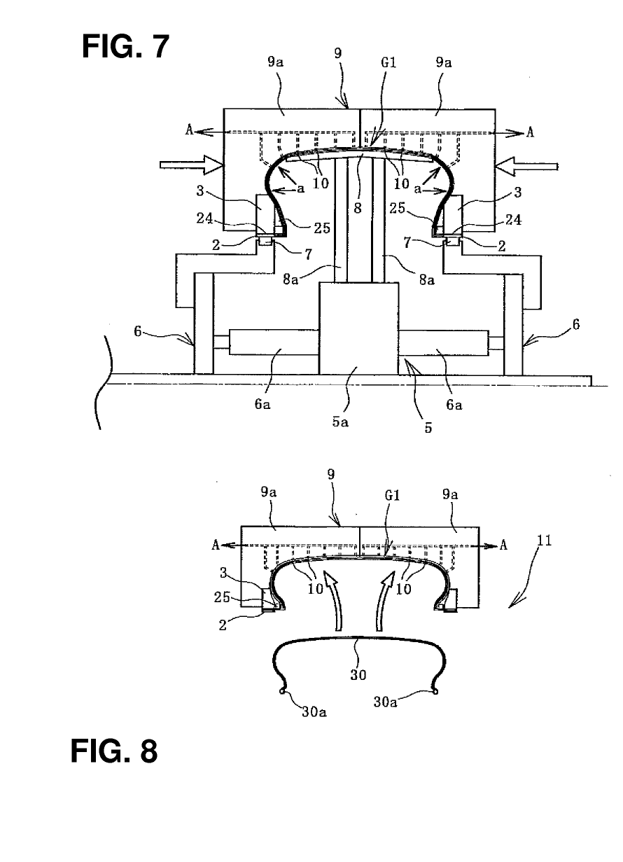

Subsequently, as illustrated in FIG. 7, a transferring/holding mold 9 is disposed on an outer peripheral side of the primary formed body G1. Suction means such as a vacuum pump is connected to the transferring/holding mold 9 in an attachable and detachable manner. The transferring/holding mold 9 includes mold sections 9a divided into two pieces in the widthwise direction. An inner peripheral surface of the transferring/holding mold 9 is formed in an annular shape, and many suction holes 10 communicating with the suction means are formed. The inner peripheral surface of the transferring /holding mold 9 has a similar shape to (a slightly large and similar shape to) an outer peripheral surface (a surface corresponding to the tread inner surface and the sidewall portions) of a rigid inner mold 11 described later.

Subsequently, while a pressure is applied to the primary formed body G1 by further injecting air a from the inner peripheral side of the primary formed body G1, the primary formed body G1 is sucked from the outer peripheral side by sucking air A through the suction holes 10 of the transferring/holding mold 9 in which the mold sections 9a are assembled. Thus, a state is achieved in which the primary formed body G1 is held by suction on the inner peripheral surface of the transferring/holding mold 9.

The film 22 is layered in the primary formed body G1. Hence, when the primary formed body G1 is held by suction on the inner peripheral surface of the transferring/holding mold 9, the primary formed body G1 can be held by suction stably, while being precisely fitted to the inner peripheral surface of the transferring/holding mold 9. When the primary formed body G1 is held by suction, it is also possible not to apply the pressure by stopping the injection of the air a from the inner peripheral side of the primary formed body G1. However, this pressure application makes it easier to fit the primary formed body G precisely to the inner peripheral surface of the transferring/holding mold 9.

After that, the pressing plates 8 are retracted by contracting the rods of the cylinders 8a, the sealing members 7 are contracted, and the inflation mold 5 is taken out from the primary formed body G1. The suction of the primary formed body G1 with the transferring/holding mold 9 is continued, until the primary formed body G1 is transferred to the rigid inner mold 11 (a bladder 30).

Subsequently, as illustrated in FIG. 8, the bladder 30 is placed inside the primary formed body G held by suction on the inner peripheral surface of the transferring/holding mold 9. The bladder 30 is made of rubber, and has a cylindrical shape. In a neutral state (unloaded state), the bladder 30 has an outer peripheral surface having a shape that is nearly the same as the profile of the inner peripheral surface of the tire to be produced. The thickness of the bladder 30 is uniform, and is set to about 1 mm to 5 mm.

Annular bladder beads 30a are provided on both ends of a cylinder of the bladder 30. The bladder beads 30a have higher rigidity than a main portion (film-like portion) of the bladder 30. In this embodiment, the bladder beads 30a are formed by rigid bodies such as wires. Alternatively, the bladder beads 30a may be formed by increasing the rubber thickness as compared to that of the main portion of the bladder 30, by using a rubber having a higher hardness than the main portion, or by increasing the rubber thickness as compared with that of the main portion and also using a rubber having a higher hardness than the main portion.

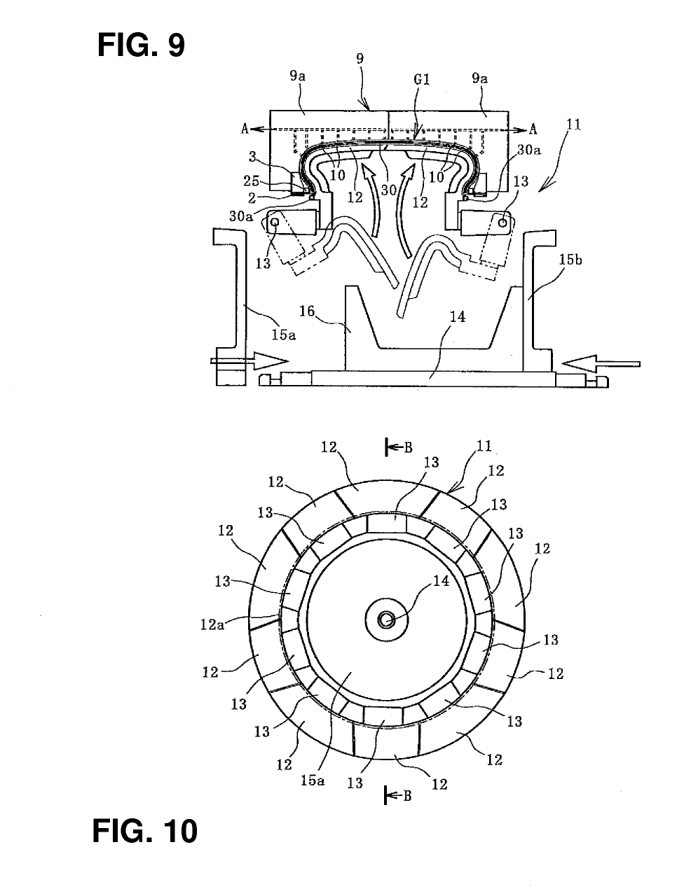

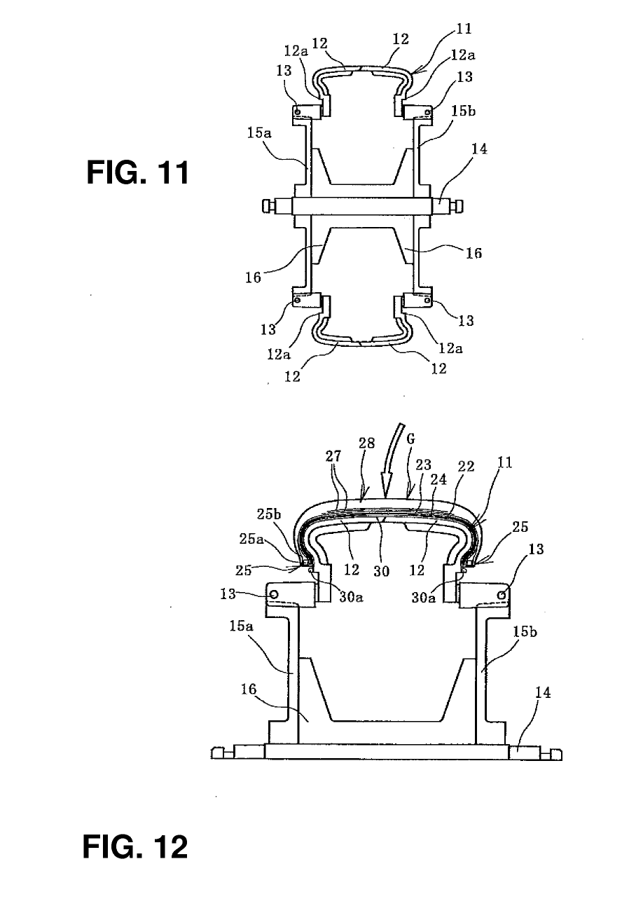

Subsequently, as illustrated in FIG. 9, the cylindrical rigid inner mold 11 is inserted into the bladder 30 which is placed inside the primary formed body G. The rigid inner mold 11 is cylindrical as illustrated in FIGS. 10 and 11, and includes divided bodies 12 divided into multiple pieces in the circumferential direction. The divided bodies 12 are further configured such that the peripheral surface of the cylinder is divided into two in the widthwise direction. Examples of a material of the rigid inner mold 11 include metals such as aluminum and aluminum alloys. The outer peripheral surface of the rigid inner mold 11 has a similar shape to (a slightly small and similar shape to) the profile of the inner peripheral surface of a tire to be produced.

These divided bodies 12 are fixed through rotating mechanisms 13 to peripheral portions of disk-shaped supporting plates 15a, 15b facing each other, and are formed into a cylindrical shape. Specifically, the divided bodies 12 on one of the two sides divided in the widthwise direction of the peripheral surface of the cylinder are disposed annularly along the peripheral portion of the supporting plate 15a on one side out of the supporting plates 15a, 15b facing each other. The divided bodies 12 on the other side of the two sides divided in the widthwise direction of the peripheral surface of the cylinder are disposed annularly along the peripheral portions of the other supporting plate 15b. In addition, bladder-bead-engaging portions 12a configured to engage with the bladder beads 30a are provided to the divided bodies 12.

A center shaft 14 is fixed to the supporting plates 15a, 15b facing each other at circle center positions thereof in such a manner that the center shaft 14 penetrates through the supporting plates 15a, 15b. The center shaft 14 is fixed to the pair of supporting plates 15a, 15b through a supporting rib 16 fixed to an outer peripheral surface of the center shaft 14. In the rigid inner mold 11 including the multiple divided bodies 12 formed in a cylindrical shape, each of the divided bodies moves in a diameter-increasing manner and a diameter-reducing manner, with the rotating mechanisms 13 being rotation centers, as will be described later.

Here, as illustrated in FIG. 9, out of the multiple divided bodies 12 divided in the circumferential direction, the divided bodies 12 on one of the divided sides in the widthwise direction are first moved in a diameter-increasing manner, with the rotating mechanisms 13 being the rotation centers. Next, the divided bodies 12 on the other side are moved in the same manner. Thus, the divided bodies 12 are assembled into an annular shape. By such an assembling operation, the rigid inner mold 11 is placed inside the bladder 30, and the rigid inner mold 11 is fitted to the outside of the bladder 30. The bladder beads 30a are fixed by engaging with the bladder-bead-engaging portions 12a of the divided bodies 12.

In a state where the rigid inner mold 11 to the outside of which the bladder 30 is fitted is disposed inside the primary formed body G held by suction as described above, the suction with the transferring/holding mold 9 is suspended, and the primary formed body G1 is transferred to an outer peripheral surface of the bladder 30. After the primary formed body G1 is transferred, the transferring/holding mold 9 is separated into the mold sections 9a, and detached from the primary formed body G1.

As described above, in the present invention, after a state is achieved in which the primary formed body G1 is held by suction on the inner peripheral surface of the transferring/holding mold 9, the primary formed body G1 is transferred to the outer peripheral surface of the bladder 30 fitted to the outside of the rigid inner mold 11. Hence, the present invention makes it possible to carry out a smooth transfer operation. In addition, the primary formed body G1 can be layered on the outer peripheral surface of the bladder 30, while being precisely fitted thereto.

Subsequently, to form a green tire G, the cylindrical rigid inner mold 11 to the outer peripheral of which the primary formed body G1 is transferred as illustrated in FIG. 12 is attached to a forming apparatus or the like by being pivotally supported through the center shaft 14. On the rigid inner mold 11, the both end portions in the widthwise direction of the carcass material 24 are turned up, and other tire-constituting members, such as the rubber members of the sidewall portions 26, the belt layers 27, and the rubber member of the tread portion 28, are layered on the outer peripheral surface of the primary formed body G1. Thus, the green tire G is formed. Although no tread pattern is formed in the green tire G, the green tire G is formed in a size that is nearly the same as and in a shape that is the same as those of the pneumatic tire 21 to be produced.

The bladder 30 is fitted to the outside of the rigid inner mold 11, and thus is firmly fixed through the bladder beads 30a to the rigid inner mold 11. Hence, decentering and the like of the green tire G formed on the outer peripheral surface of the bladder 30 are prevented, and it is possible to stably form the green tire G precisely fitted to the outer peripheral surface of the bladder 30. These are advantageous for improving the uniformity of the tire to be produced.

Subsequently, the rigid inner mold 11 is detached from the formed green tire G. For detaching the rigid inner mold 11, first, the engagement between the rotating mechanisms 13 and the supporting plates 15a, 15b is released by holding the rotating mechanisms 13 of the divided bodies 12 from the both sides in the widthwise direction of the rigid inner mold 11. In this state, the one supporting plate 15a is detached from the center shaft 14, and the one supporting plate 15a and the other supporting plate 15b to which the center shaft 14 is fixed are moved to the outside of the green tire G.

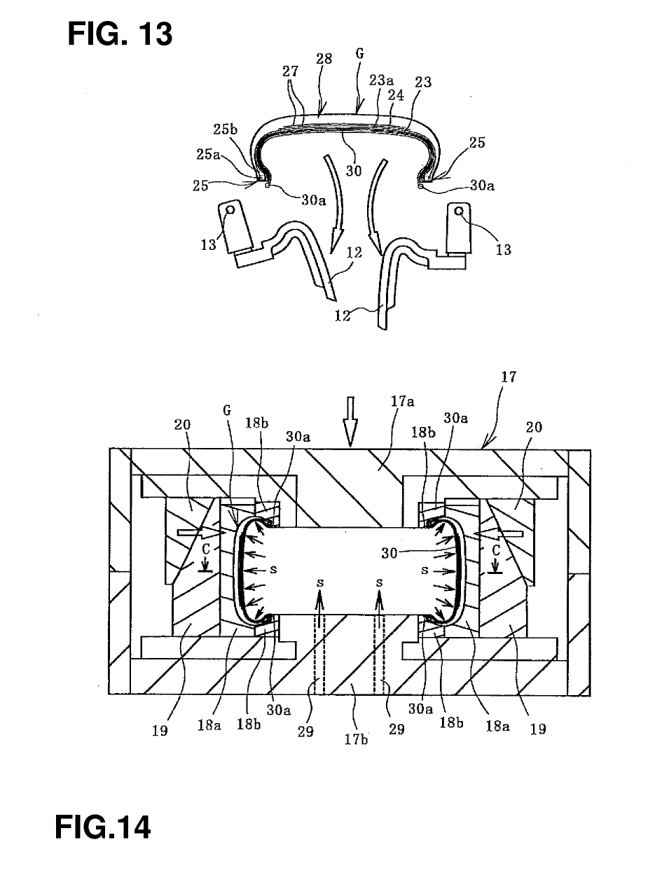

Subsequently, as illustrated in FIG. 13, the divided bodies 12 on one side in the widthwise direction (on the right side in FIG. 13) are rotated toward the tire inner side about the rotating mechanisms 13, in such a manner that the diameter of the cylindrical rigid inner mold 11 is reduced. After that, the divided bodies 12 on the other side in the widthwise direction (on the left side in FIG. 13) are rotated toward the tire inner side about the rotating mechanisms 13, in such a manner that the diameter of the cylindrical rigid inner mold 11 is reduced. The divided bodies 12 are rotated toward the tire inner side as described above, and then detached by being moved to the outside of the green tire G. Thus, the green tire G to the inside of which the bladder 30 is fitted can be obtained.

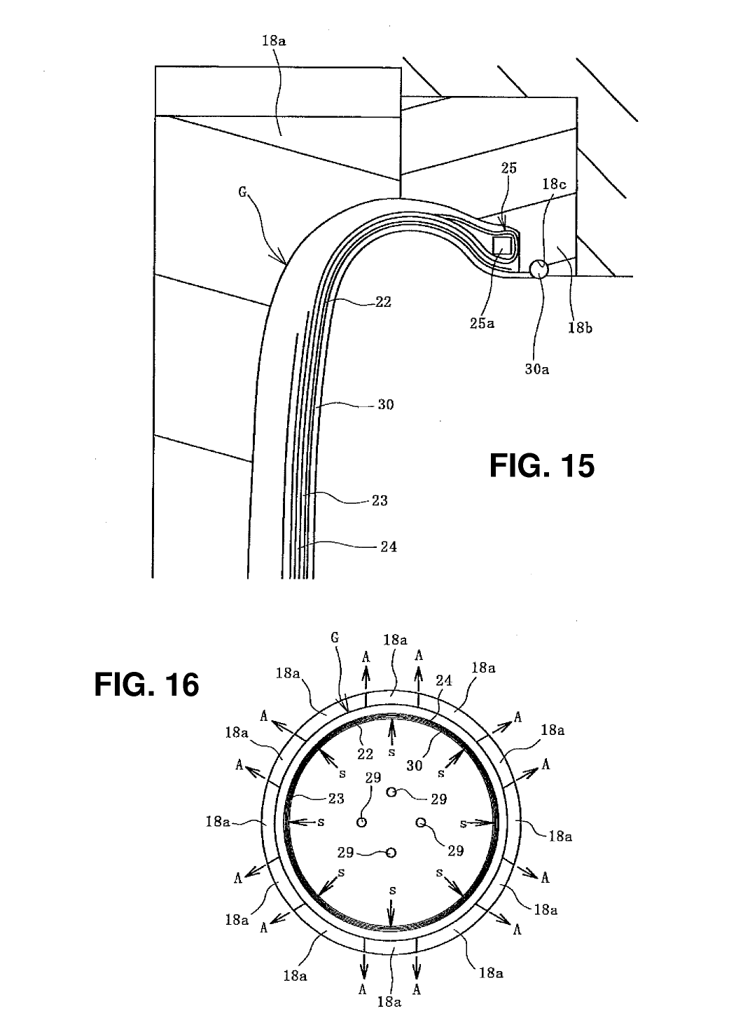

Subsequently, as illustrated in FIGS. 14 and 15, the green tire G to the inside of which the bladder 30 is fitted is disposed at a predetermined position inside a vulcanizing mold placed in a vulcanizing apparatus 17. The vulcanizing mold includes multiple sectors 18a divided in the tire circumferential direction, and upper and lower annular side plates 18b, 18b. Bladder-bead-engaging portions 18c configured to engage with the bladder beads 30a are provided to the upper and lower side plates 18b, 18b.

The lower side plate 18b is fixed to a lower housing 17b on which the sectors 18a are mounted. Back segments 19 having inclined surfaces are attached to back surfaces of the sectors 18a. Guide members 20 having inclined surfaces and the upper side plate 18b are fixed to an upper housing 17a.

The green tire G is positioned at a predetermined position by mounting a lower bead portion of the green tire G on the lower side plate 18b, and engaging the bladder bead 30a with the bladder-bead-engaging portion 18c. After that, the upper housing 17a is moved downward. The inclined surfaces of the guide members 20 moving downward with this downward movement of the upper housing 17a abut on the inclined surfaces of the back segments 19. With the downward movement of the guide members 20, the sectors 18a, together with the back segments 19, gradually move toward the center shaft 14. Specifically, the sectors 18a in a diameter-increased state move in a diameter-reducing manner, and are assembled into an annular shape. Then, the upper side plate 18b moving downward is disposed on upper inner peripheral portions of the sectors 18a assembled into the annular shape. An upper bead portion of the green tire G abuts on the upper side plate 18b, and the bladder bead 30a engages with the bladder-bead-engaging portion 18c.

The upper and lower bead portions of the green tire G each take a sealed state by close contact with the upper and lower side plates 18b. As a result, an inner peripheral cavity portion of the green tire G is tightly sealed by being surrounded by the vulcanizing mold, the upper housing 17a, and the lower housing 17b.

Note that the green tire G formed on the outer periphery of the rigid inner mold 11 is formed into a shape that is nearly the same as the shape of the tire to be produced, precisely with reference to the bead rings 25. Hence, the green tire G hardly deforms, even when the rigid inner mold 11 is detached therefrom. Accordingly, the green tire G can be disposed precisely at a predetermined position, when the lower bead portion of the green tire G is mounted on the lower side plate 18b, and the bladder bead 30a is engaged with the bladder-bead-engaging portion 18c.

Subsequently, the vulcanizing mold, which is clamped, is heated to a predetermined temperature. A heating fluid such as steam s is injected into the inner peripheral cavity portion of the green tire G through communicating paths 29 provided in the lower housing 17b. The bladder 30 is inflated by applying a pressure to the inner peripheral surface (the inner peripheral cavity portion) of the bladder 30 by the direct injection of the heating fluid in this manner, and simultaneously the green tire G is vulcanized by heating.

The pressure for inflating the bladder 30 is, for example, about 0.01 MPa to 3.0 MPa. This inflation pressure enables a favorable vulcanization without any excessive load on the green tire G (the film 22).

By inflating the bladder 30, the unvulcanized rubber in the tire-constituting members is pressed against the inner peripheral surfaces of the sectors (the vulcanizing mold) 18a, as illustrated in FIG. 16. With this pressing, the unvulcanized rubber flows in the circumferential direction of the sectors 18a. Accordingly, even when the volumes of the tire-constituting members of the green tire G are unevenly distributed, the unevenness is corrected, and the uniformity of the pneumatic tire 21 to be produced can be improved.

Note that when inflated, the bladder 30 does not deform greatly, and is only slightly increased in diameter. In addition, since the outer peripheral surface of the bladder 30 in the neutral state has a shape that is nearly the same as the profile of the inner peripheral surface of the tire to be produced, no excessive force acts on the film 22, and problems such as breakage of the film 22 can be avoided.

With the vulcanization of the green tire G, the film 22 is brought into close contact with and joined to the adjacent rubber member (the tie rubber 23). The pneumatic tire 21, which has a light weight and is excellent in air-permeation prevention performance and uniformity, can be produced in this manner.

As for the vulcanization, the green tire G is preferably vulcanized in a negative pressure state by forcible suction of air A from the inside to the outside of the vulcanizing mold. For example, evacuation is conducted with a vacuum pump through mating surfaces of the adjacent sectors (the vulcanizing mold) 18a. This evacuation makes it possible to remove air between the layered tire-constituting members and air in the tire-constituting members (rubber members). Hence, problems due to air inclusion in the produced pneumatic tire 21 can be prevented, and the quality thereof can be improved.

To increase the joining force between the film 22 and the adjacent rubber member, it is also possible to provide an adhesive layer in advance on a surface of the film 22. The tie rubber 23 may be disposed to entirely cover the outer peripheral surface of the film 22, or may also be disposed to partially cover the outer peripheral surface of the film 22. The tie rubber 23 may be eliminated, as long as a certain joining strength can be secured between the film 22 and the adjacent rubber member.

The vulcanizing mold can be heated by various heat sources, and, for example, a heater embedded in the vulcanizing mold may be used. The heating with a heater enables a precise temperature control.

In addition, when the green tire G is vulcanized, the rigid inner mold 11 is not disposed inside the vulcanizing mold. Hence, the rigid inner mold 11 can be used freely during the vulcanization. For this reason, the number of green tires G which can be formed with one rigid inner mold 11 in a certain period is increased, so that the productivity can be improved by effectively utilizing the rigid inner mold 11. This makes it possible to reduce the number of the rigid inner molds 11 prepared.

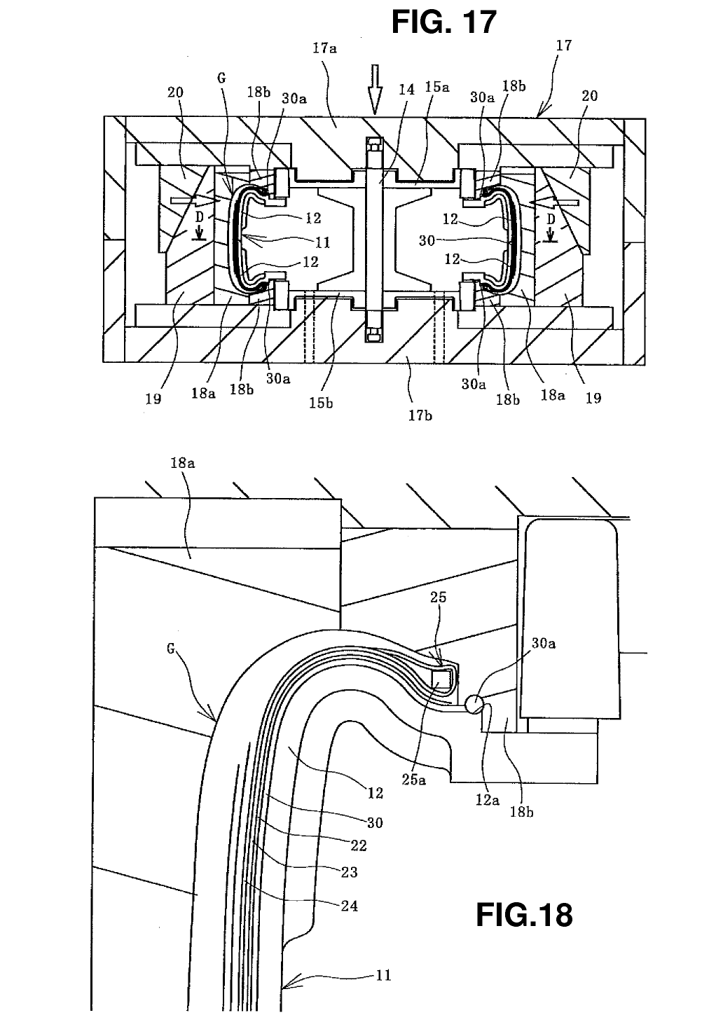

As illustrated in FIGS. 17 and 18, it is also possible to vulcanize the green tire G formed by using the rigid inner mold 11, while the green tire G is disposed inside the vulcanizing mold placed in the vulcanizing apparatus 17, together with the rigid inner mold 11 to the outside of which the bladder 30 is fitted. In the case of this embodiment, a lower end portion of the center shaft 14 of the rigid inner mold 11 holding the green tire G is inserted into a center hole of the lower housing 17b. Then, the upper housing 17a is moved downward, and the sectors 18a are moved in a diameter-reducing manner, and are assembled into an annular shape. The upper side plate 18b moved downward is disposed on the upper inner peripheral portions of the sectors 18a assembled into the annular shape. An upper end portion of the center shaft 14 takes a state of being inserted into a center hole of the upper housing 17a.

The formed green tire G is placed inside the vulcanizing mold, together with the rigid inner mold 11 to the outside of which the bladder 30 is fitted. Hence, unlike conventional cases, the operation of detaching the green tire G form a making drum is unnecessary, so that this step can be eliminated. In addition, the center holes of the upper housing 17a and the lower housing 17b are formed with predetermined precisions. Hence, positioning can be conducted only by inserting the center shaft 14 of the rigid inner mold 11. Moreover, the bladder beads 30a are fixed, while engaging the bladder-bead-engaging portions 12a of the divided bodies 12. Hence, the green tire G can be easily disposed at a predetermined position inside the forming mold, with a further high precision. This improves the productivity, and enables efficient production of the pneumatic tire 21.

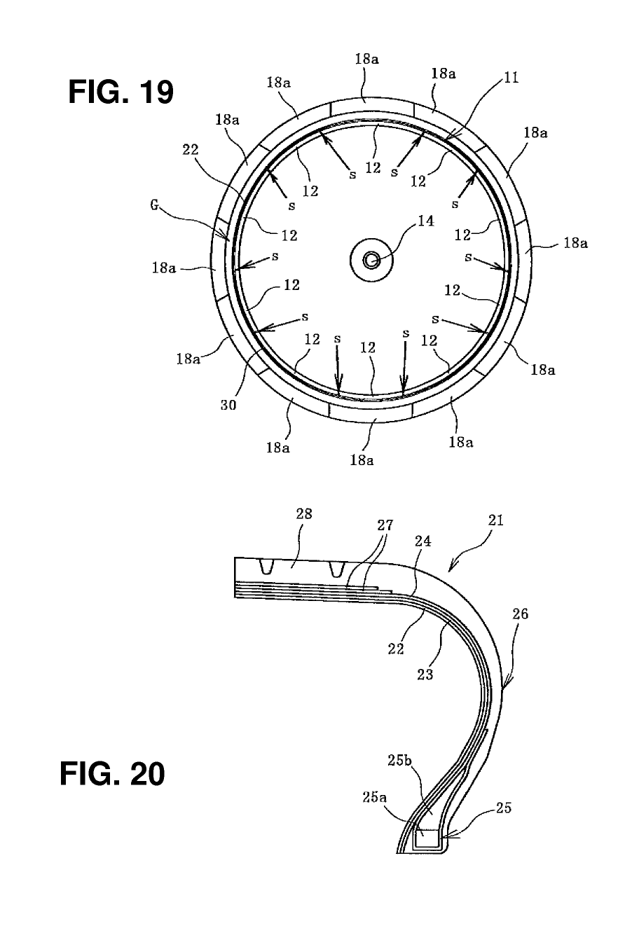

Subsequently, as illustrated in FIG. 19, the rigid inner mold 11 and the vulcanizing mold, which is clamped, are heated to a predetermined temperature, and a pressure is applied to the bladder 30 by supplying steam s from the inner peripheral side of the bladder 30. Thus, the bladder 30 is caused to take an inflated state, and the green tire G is vulcanized in this state. Also in this embodiment, even when the volumes of the tire-constituting members of the green tire G are unevenly distributed, the unevenness is corrected, and the uniformity of the pneumatic tire 21 to be produced can be improved.

In the case of this embodiment, the formed green tire G is supported by the rigid inner mold 11, until vulcanized. Hence, it is possible to reduce the occurrence of unnecessary deformation.

As for the vulcanization, it is preferable to vulcanize the green tire G in a negative pressure state by forcible suction of air A from the inside to the outside of the vulcanizing mold also in this embodiment.

In each of the above-described embodiments, a case where a radial tire is produced is shown as an example. However, the present invention can also be applied to a case where a bias tire is produced.

### EXPLANATION OF REFERENCE NUMERALS

1 primary making drum

5 inflation mold

8 pressing plate

9 transferring/holding mold

11 rigid inner mold

12 divided body

12a bladder-bead-engaging portion

17 vulcanizing apparatus

18a sector

18b side plate

18c bladder-bead-engaging portion

21 pneumatic tire

22 film

24 carcass material

25 bead ring

27 belt layer

29 communicating path

30 bladder

30a bladder bead

G1 primary formed body

G green tire

1. A method for producing a pneumatic tire in which a green tire is formed on an outer periphery of a cylindrical rigid inner mold including a plurality of divided bodies and having an outer peripheral surface with a similar shape to a profile of an inner peripheral surface of a tire to be produced, and then the green tire is vulcanized, the method by comprising:
forming a primary formed body in such a manner that
bead rings are fitted to the outside of both end portions in a widthwise direction of a cylindrical body having at least a film made of a thermoplastic resin or a thermoplastic elastomer composition obtained by blending an elastomer with a thermoplastic resin, and a carcass material disposed on an outer peripheral side of the film;
forming a green tire in such a manner that
a center portion in the widthwise direction of the primary formed body is caused to bulge toward an outer peripheral side, and is held by suction on an inner peripheral surface of a transferring/holding mold having a similar shape to the outer peripheral surface of the rigid inner mold,
in a state where the rigid inner mold to the outside of which a bladder is fitted is disposed inside the primary formed body held by suction, the suction with the transferring/holding mold is suspended and the primary formed body is transferred to an outer peripheral surface of the bladder, the bladder having a uniform thickness and having the outer peripheral surface that is nearly the same in a neutral state as the profile of the inner peripheral surface of the tire to be produced, and
subsequently both end portions in the widthwise direction of the carcass material are turned up on the outer periphery of the rigid inner mold, and another tire-constituting members is layered on an outer peripheral surface of the primary formed body; and
vulcanizing the green tire in such a manner that
the green tire is disposed inside a vulcanizing mold placed in a vulcanizing apparatus, together with the rigid inner mold to the outside of which the bladder is fitted, and the vulcanizing mold is clamped, and
the vulcanizing mold is heated to a predetermined temperature, and the bladder is inflated from an inner peripheral side thereof with a heating fluid.

2. A method for producing a pneumatic tire in which a green tire is formed on an outer periphery of a cylindrical rigid inner mold including a plurality of divided bodies and having an outer peripheral surface with a similar shape to a profile of an inner peripheral surface of a tire to be produced, and then the green tire is vulcanized, the method by comprising:
forming a primary formed body in such a manner that
bead rings are fitted to the outside of both end portions in a widthwise direction of a cylindrical body having at least a film made of a thermoplastic resin or a thermoplastic elastomer composition obtained by blending an elastomer with a thermoplastic resin, and a carcass material disposed on an outer peripheral side of the film;
forming a green tire in such a manner that
a center portion in the widthwise direction of the primary formed body is caused to bulge toward an outer peripheral side, and is held by suction on an inner peripheral surface of a transferring/holding mold having a similar shape to the outer peripheral surface of the rigid inner mold,
in a state where the rigid inner mold to the outside of which a bladder is fitted is disposed inside the primary formed body held by suction, the suction with the transferring/holding mold is suspended and the primary formed body is transferred to an outer peripheral surface of the bladder, the bladder having a uniform thickness and having the outer peripheral surface that is nearly the same in a neutral state as the profile of the inner peripheral surface of the tire to be produced, and
subsequently both end portions in the widthwise direction of the carcass material are turned up on the outer periphery of the rigid inner mold, and another tire-constituting member is layered on an outer peripheral surface of the primary formed body; and
vulcanizing the green tire in such a manner that
after the rigid inner mold is detached from the green tire, the green tire to the inside of which the bladder is fitted is disposed inside a vulcanizing mold placed in an vulcanizing apparatus, and the vulcanizing mold is clamped, and
the vulcanizing mold is heated to a predetermined temperature, and the bladder is inflated from an inner peripheral side thereof with a heating fluid.

3. The method for producing a pneumatic tire according to claim 1, wherein in the course of holding the primary formed body by suction on the inner peripheral surface of the transferring/holding mold, the transferring/holding mold is disposed on the outer peripheral side of the primary formed body, and a pressure is applied to the primary formed body from an inner peripheral side of the primary formed body.

4. The method for producing a pneumatic tire according to claim 1, wherein in the vulcanization of the green tire, the bladder is inflated at a pressure of 0.01 MPa to 3.0 MPa from the inner peripheral side.

5. The method for producing a pneumatic tire according to claim 1, wherein the green tire disposed inside the vulcanizing mold is vulcanized, while air is being sucked from the inside to the outside of the vulcanizing mold.

6. The method for producing a pneumatic tire according to claim 1, wherein the film is located at the innermost periphery of the primary formed body.

7. The method for producing a pneumatic tire according to claim 2, wherein in the course of holding the primary formed body by suction on the inner peripheral surface of the transferring/holding mold, the transferring/holding mold is disposed on the outer peripheral side of the primary formed body, and a pressure is applied to the primary formed body from an inner peripheral side of the primary formed body.

8. The method for producing a pneumatic tire according to claim 2, wherein in the vulcanization of the green tire, the bladder is inflated at a pressure of 0.01 MPa to 3.0 MPa from the inner peripheral side.

9. The method for producing a pneumatic tire according to claim 2, wherein the green tire disposed inside the vulcanizing mold is vulcanized, while air is being sucked from the inside to the outside of the vulcanizing mold.

10. The method for producing a pneumatic tire according to claim 2, wherein the film is located at the innermost periphery of the primary formed body.
